(19) United States
(12) Patent Application Publication
(10) Pub. No.: US 2007/0268264 A1
(43) Pub. Date: Nov. 22, 2007

(54) Electronic devices

(75) Inventors: Mikko Aarras, Helsinki (FI); Niilo Alfthan, Tampere (FI); Simon Bradford, Middlesex (GB); Claus Allan Christensen, Kobenhavn (DK); Anthony Dalby, London (GB); Axel E. Meyer, Helsinki (FI); William Sermon, Buckinghamshire (GB); Sameer Shirgaonkar, London (GB); Crispian Tompkin, Los Angeles, CA (US); Chee Wong, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/436,202

(22) Filed: May 16, 2006

(51) Int. Cl. G06F 3/041

(52) U.S. Cl. 345/173

(57) ABSTRACT

A foldable electronic apparatus comprising first and second parts being arranged to be foldable with respect to each other about a folding axis to define first and second apparatus folding configurations, wherein the first and second parts comprise respective first and second displays, wherein the device is arranged to have respective first and second operating modes according to whether the apparatus is in the first configuration or the second configuration, and wherein, in the first operating mode, the first display is arranged to act as a user input, and in the second operating mode, the first and second displays are arranged to act as displays.

### BACKGROUND TO THE INVENTION

The invention relates to the field of electronic devices, in particular handheld electronic device comprising electronic displays. Although such devices may be hand-held in use, they do not have to be hand-held in use.

Electronic devices, particularly user-portable radiotelephones (e.g. mobile cellular phones), can comprise two parts which can be folded upon one another in closed and open configurations of the device. Such arrangements allow for compact design of the electronic devices. Such devices often incorporate displays.

There is a need for larger displays as the size of portable electronic devices incorporating display gets smaller.

### BRIEF SUMMARY OF THE INVENTION

In a first aspect, the present invention provides a foldable electronic device comprising first and second parts being arranged to be foldable with respect to each other about a folding axis to define first and second device folding configurations, wherein the first and second parts comprise respective first and second displays, wherein the device is arranged to have respective first and second operating modes according to whether the device is in the first configuration or the second configuration, and wherein, in the first operating mode, the second display is arranged to act as a user input, and in the second operating mode, the first and second displays are arranged to act as displays.

The device may be arranged such that the first and second folding configurations may be self-supporting configurations allowing the device to be stably placed on a support surface with the folding axis substantially perpendicular to the support surface.

The device may be arranged such that the folding angle between the first and second parts is substantially in the range 135-180 degrees for the first and second configurations.

The device may be arranged such that the first configuration is provided when the folding angle between the first and second parts is substantially in the range 135-160 degrees.

The device may be arranged such that the second configuration is provided when the folding angle between the first and second parts is substantially in the range 170-180 degrees.

The device may be arranged such that the first configuration is a closed configuration of the device. The device may be arranged such that the second configuration is an open configuration of the device. The device may be arranged such that the first and second configurations are open configurations of the device.

The device may be arranged such that the first display acts as a display in the first configuration.

The device may be a communications device and the first part may comprise one or more speaker elements to transmit audio to a user of the device and the second part may comprise one or more microphone elements to receive audio from a user of the device.

The communications device may be arranged to make and/or receive communication transmissions in the first and second configuration. The communication transmission may be audio and/or video telephony transmissions.

The device may be arranged such that the first and second displays are arranged on respective first and second faces of respective first and second parts, the respective display faces being arrangeable to be opposingly facing one another, and wherein the first and second configurations are configurations in which the faces are arranged to be opposing one another.

The device may be arranged to display an image in the second operating mode, wherein the first display is arranged to display a portion of the image and the second display is arranged to display the remaining portion of the image.

The device may be arranged such that the images on the respective displays in the second configuration are un-related images.

The device may be arranged such that in the second configuration, one of the displays provides a visual user interface to an applications program to allow a user to control the display of images on the other display.

The device may comprise one or more user input elements and the device may be arranged such that in the second configuration, one or more of the user input elements is arranged to provide input to an applications program to allow a user to control the display of images on one or both of the displays.

The device may be arranged such that the first and second displays are arranged to act as user input elements in the second configuration.

One or more user input elements may be provided adjacent the first and/or second displays. One or more user input elements may be provided adjacent the second display to be operable in the second configuration.

The displays may be arranged in proximity to the folding axis such that when the device is in the second configuration, the space between adjacent first and second displays does not substantially distract a user when viewing both adjacent displays at the same time.

The device may comprise one or more camera elements arranged to allow a user to view camera images on one or more of the displays.

The device may be arranged such that in the second configuration, one of the displays can show a previously captured image and the other display can shown an image of a scene to be captured by the device camera. The previously captured image may an image previously captured by the device camera. The previously captured image may an image previously captured by the device camera immediately preceding the scene displayed by the device camera.

A camera device may be attachable to the device. In such a case, the camera device is not integral with the device.

The first and second parts may be foldable about the folding axis to completely overlie one another. The device may be arranged such that the displays always face each other about the folding axis. However, in other embodiments, the device may be arranged such that the displays can be moved away from the facing position.

The first and second parts may be arranged to be foldable only about a single folding axis. The first and second parts may be arranged to be foldable about additional folding axes. The first and second parts may be arranged to be rotatable with respect to one another about a rotation axis.

The device may be arranged to be manually foldable. The device may be arranged to comprise one or more spring mechanism to assist folding of the device into one or more of the configurations.

The device may be arranged to be automatically foldable upon the user actuation of a user operable element. The device may be arranged such that the folding of the device into one or more of the configurations may be motor driven.

The device may have stable first and second configurations, with one or more intermediate configurations being comparatively unstable.

The device may be lockable in a closed configuration.

The device may be arranged to be handheld in the first configuration.

The device may be arranged to continuously monitor the folding configuration to determine the operating mode of the device. The device may be arranged to determine whether the folding angle between the first and second parts has reached a predetermined angle to determine the operating mode of the device.

The displays may be provided on inner faces of the parts. The displays may be provided on outer faces of the parts.

The device may have additional operating modes based on other configurations of the device.

According to a second aspect the present invention provides a foldable electronic apparatus comprising first and second parts being arranged to be foldable with respect to each other about a folding axis to define first and second apparatus folding configurations, wherein the first and second parts comprise respective first and second displays, wherein the apparatus is arranged to have respective first and second operating modes according to whether the apparatus is in the first configuration or the second configuration, and wherein, in the first operating mode, the first display is arranged to act as a user input, and in the second operating mode, the first and second displays are arranged to act as displays.

According to a third aspect, the present invention provides a foldable electronic device comprising first and second parts being arranged to be foldable with respect to each other about a folding axis to define first and second device folding configurations, wherein the first and second parts comprise respective first and second displays, wherein the device is arranged to have respective first and second operating modes according to whether the device is in the first configuration or the second configuration, and wherein, in the first operating mode, the first display is arranged to provide one or more indications to one or more adjacent user inputs, and in the second operating mode, the first and second displays are arranged to act as displays.

According to a fourth aspect, the present invention provides a foldable electronic apparatus according to the third aspect.

The apparatus may be modules of the device. One or more of the displays may be means for displaying. One or more of the user input elements may be means for user input.

The invention encompasses one or more aspects, embodiments and/or features of the aspects and/or embodiments in isolation and various combinations whether or not specifically mentioned in isolation or combination. Corresponding means for performing the functions disclosed are within the present disclosure.

### BRIEF DESCRIPTION OF THE FIGURES

Specific embodiments of the present invention will now be described with reference to the following Figures in which:

FIG. 1 is a schematic illustration of an electronic device according to one embodiment of the invention; and

FIG. 2 shows plan views of the electronic device of FIG. 1 in a first (FIG. 2a) and second (FIG. 2b) configurations;

FIG. 3 is a perspective view of an electronic device according to one embodiment of the invention.

### DETAILED DESCRIPTION OF SPECIFIC EMBODIMENTS OF THE INVENTION

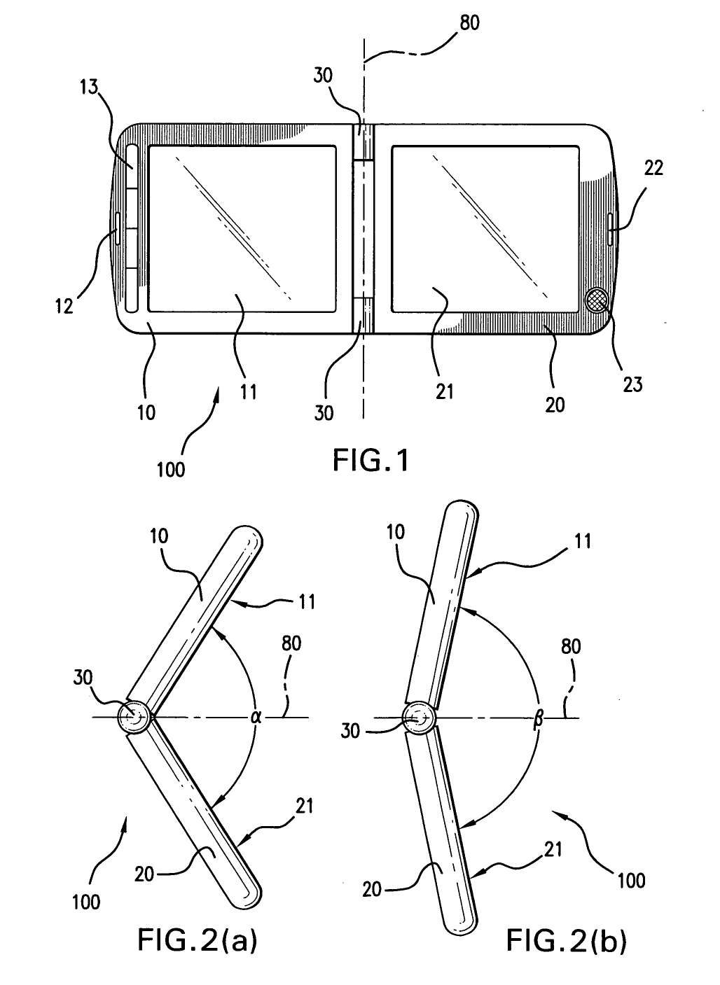

A schematic illustration of an electronic device 100 according to one embodiment of the invention is shown in FIG. 1. In this case, the device is a radiotelephone (such as a so called mobile telephone) with additional audio/visual functionality. The additional audio/visual functionality allows the user to use the device to play and/or record audio (e.g. MP3 or other music/audio format) and/or video. In other embodiments, the device 100 may not have radiotelephone functionality.

The device 100 comprises two parts 10, 20 which are foldable about a folding axis 80. Hinge mechanisms 30 are used to allow the parts to be folded into a number of configurations. The parts 10,20 can be folded over one another such that the inner faces of the device touch in a closed configuration. In the closed configuration, the parts 10,20 can be considered to have a zero folding angle between them, whereas in an open configuration, the parts 10, 20 have a non-zero folding angle defined between them. In this case, the device 100 can be opened to a nearly 360 degrees folding angle such that the inner faces of the device 100 in the closed configuration form the outer faces of the device 100 in the fully open configuration.

In this case, the parts 10, 20 are generally rectangular. Other embodiments may have different shaped parts 10, 20. The inner faces of the parts 10, 20 each comprise a respective electronic display 11, 21. Thus, the first part 10 has a first display 11 and the second part 20 has a second display 21. As such, these parts 10, 20 comprise respective first and second means for displaying with said first and second displays.

It will be appreciated that these displays 11, 21 are located on either side of the folding axis 80. In this embodiment, the displays 11, 21 are positioned in close proximity to the folding axis 80. Thus, the gap between the adjacent ends of the displays 11, 21 is quite small in a number of open configurations.

The first part 10 comprises a microphone port 12 and a number of user input elements 13. In this case, the user input elements are keys. The second housing 20 comprises a speaker port 22, and a camera 23. The device 100 is sized so that it is possible to handhold the device when making a telephone call.

The device 100 can be opened into many configurations. Two such configurations are shown in FIG. 2 (in plan view). In FIG. 2a, the parts 10, 20 are folded to provide a first device configuration, and in FIG. 2b, the parts 10, 20 are folded to provide a second device configuration. In the first configuration, the folding angle between the parts is α, and in the second configuration, the folding angle between the parts is β.

The user can answer and/or make a call by opening the foldable device 100 into an open configuration. In some embodiments, the user may also be able to answer and/or make a call in the closed configuration. In one or more general embodiments, the device 100 is folded into an open configuration to allow access to one or more user input elements (e.g. 12, 11, 23) and/or output elements (11. 21, 22) located on one or more of the inner faces of the device 100.

When the device 100 is opened, the first display 11 is arranged to be a user input element (e.g. a touch sensitive screen). Thus, the user can control one or more of the functions of the device 100 by actuating one or more regions on the display 11. In this case, the display 11 provides one or more indications to one or more particular locations which should be actuated (e.g. by depressing) to control one or more of the operations/functions of the device 100.

In one embodiment, the user is given indications to actuate regions of the display 11. In other embodiments, the user may be given indications to actuate one or more user input elements adjacent the first display 11. In this way, for example, input elements 13 can be used as so-called “soft keys”, the function performed by them being indicated on an adjacent screen, the function depending on the particular location in the user interface program.

Thus, in the first configuration, the display 11 acts as a user input and/or gives indications to one or more adjacent user input elements 13 i.e. the device 100 operates in a first operating mode. In other embodiments, the adjacent user input elements may be on the other side of the hinge 30 on part 20.

As the device is further opened passed a critical folding angle α_{crit}, which in this case is 160 (+/−10 degrees), the device 100 is configured to move into a second operating mode. The detection of this critical folding angle can be done by using one or more mechanical/electrical/electromechanical sensors in the device 100.

In the second operating mode, both displays 11, 21 act as displays. In certain embodiments, one or more the displays may also act as user input elements and/or give indications to one or more adjacent user input elements.

In this embodiment, the folding angle β in the second configuration is 170-180 (+/−10 degrees). The second configuration folding angle β is such that the two adjacent displays 11, 21 are substantially in the same plane. The two adjacent displays can be used as a continuous single display. Thus, an image can be partially displayed on the first display 11, and the rest of the image can be displayed on the adjacent second display 21.

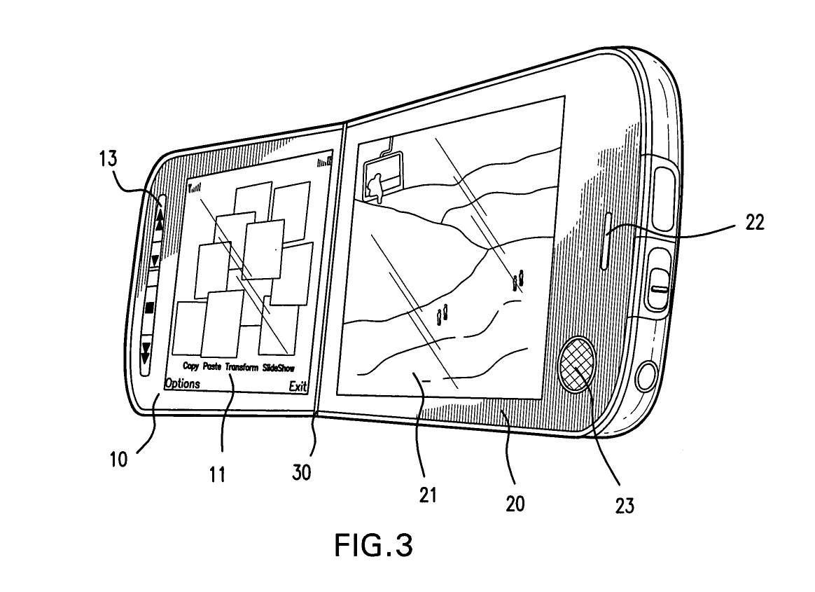

As the underneath of the device 100 is relatively flat, the device 100 can be placed on a support surface to be free-standing (FIG. 3). In other embodiments, a stand may be required, and the device 100 may be configured to be attachable to the stand.

In the second configuration, the first display 11 may be useable to provide control over the image which is provided on the second display 21. This may also be true in the first configuration. FIG. 3 shows that display 11 is a user interface which allows a user to activate copy, paste, transform, slideshow functions using the display 11. Further options are actuatable (bottom left “options” and bottom right “exit”), and the strength of the battery and the radiosignal strength are also indicated on the display 11. FIG. 3 can be for both first and second configurations.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

For example, aspects described in relation to the first display may be on the second display (and vice versa). The first display may not necessarily comprise a microphone port (or microphone functionality). In other embodiments, the radiotelephone functionality may not be linked with the first and configurations of the device. The second display 21 may be turned off or turned on in the first configuration. The device may or may not receive/transmit audio/video transmissions (including broadcast transmissions). The displays may or may not be the same size. The foldable parts may or may not be the same size. Many different mechanisms to detect the folding angle may be provided.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A foldable electronic apparatus comprising first and second parts being arranged to be foldable with respect to each other about a folding axis to define first and second apparatus folding configurations, wherein the first and second parts comprise respective first and second displays, wherein the device is arranged to have respective first and second operating modes according to whether the apparatus is in the first configuration or the second configuration, and wherein, in the first operating mode, the first display is arranged to act as a user input, and in the second operating mode, the first and second displays are arranged to act as displays.

2. The apparatus of claim 1, wherein the apparatus is arranged such that the first and second folding configurations are self-supporting configurations allowing the apparatus to be stably placed on a support surface with the folding axis substantially perpendicular to the support surface.

3. The apparatus of claim 1, wherein the apparatus is arranged such that the folding angle between the first and second parts is substantially in the range 135-180 degrees for the first and second configurations.

4. The apparatus of claim 1, wherein the apparatus is arranged such that the first configuration is provided when the folding angle between the first and second parts is substantially in the range 135-160 degrees.

5. The apparatus of claim 1, wherein the apparatus is arranged such that the second configuration is provided when the folding angle between the first and second parts is substantially in the range 170-180 degrees.

6. The apparatus of claim 1, wherein the apparatus is arranged such that the first and second configurations are open configurations of the apparatus.

7. The apparatus of claim 1, wherein the apparatus is arranged such that the first display acts as a display in the first configuration.

8. The apparatus of claim 1, wherein the apparatus is a communications apparatus and the first part comprises one or more speaker elements to transmit audio to a user of the apparatus and the second part comprises one or more microphone elements to receive audio from a user of the apparatus.

9. The apparatus of claim 8, wherein the apparatus is arranged to make and/or receive communication transmissions in the first and second configuration.

10. The apparatus of claim 1, wherein the apparatus is arranged such that the first and second displays are arranged on respective first and second faces of respective first and second parts, the respective display faces being arrangeable to be opposingly facing one another, and wherein the first and second configurations are configurations in which the faces are arranged to be opposing one another.

11. The apparatus of claim 1, wherein the apparatus is arranged to display an image in the second operating mode, wherein the first display is arranged to display a portion of the image and the second display is arranged to display the remaining portion of the image.

12. The apparatus of claim 1, wherein the apparatus is arranged such that the images on the respective displays in the second configuration are un-related images.

13. The apparatus of claim 1, wherein the apparatus is arranged such that in the second configuration, one of the displays provides a visual user interface to an applications program to allow a user to control the display of images on the other display.

14. The apparatus of claim 1, wherein the apparatus comprises one or more user input elements and wherein the apparatus is arranged such that in the second configuration, one or more of the user input elements is arranged to provide input to an applications program to allow a user to control the display of images on one or both of the displays.

15. The apparatus of claim 1, wherein the apparatus is arranged such that the first and second displays are arranged to act as user input elements in the second configuration.

16. The apparatus of claim 1, wherein one or more user input elements are provided adjacent the first and/or second displays.

17. The apparatus of claim 1, wherein one or more user input elements are provided adjacent the second display to be operable in the second configuration.

18. The apparatus of claim 1, wherein the displays are arranged in proximity to the folding axis such that when the apparatus is in the second configuration, the space between adjacent first and second displays does not substantially distract a user when viewing both adjacent displays at the same time.

19. The apparatus of claim 1, wherein the apparatus comprises one or more camera elements arranged to allow a user to view camera images on one or more of the displays.

20. The apparatus of claim 1, wherein the apparatus is arranged such that in the second configuration, one of the displays is able to show a previously captured image and the other display is able to provide an image of a scene to be captured by the apparatus camera.

21. The apparatus of claim 1, wherein the apparatus is arranged to provide first and second parts which are foldable about the folding axis to completely overlie one another.

22. The apparatus of claim 1, wherein the apparatus is arranged such that the displays always face each other about the folding axis.

23. The apparatus of claim 1, wherein the first and second parts are arranged to be rotatable with respect to one another about a rotation axis.

24. The apparatus of claim 1, wherein the apparatus is arranged to be manually foldable.

25. The apparatus of claim 1, wherein the apparatus is arranged to comprise one or more spring mechanism to assist folding of the apparatus into one or more of the configurations.

26. The apparatus of claim 1, wherein the apparatus has stable first and second configurations, with one or more intermediate configurations being comparatively unstable.

27. The apparatus of claim 1, wherein the apparatus is arranged to be handheld in the first configuration.

28. The apparatus of claim 1, wherein the apparatus is arranged to determine whether the folding angle between the first and second parts has reached a predetermined angle to determine the operating mode of the apparatus.

29. The apparatus of claim 1, wherein the apparatus is an electronic device.

30. A foldable electronic apparatus comprising first and second parts being arranged to be foldable with respect to each other about a folding axis to define first and second apparatus folding configurations, wherein the first and second parts comprise respective first and second displays, wherein the apparatus is arranged to have respective first and second operating modes according to whether the apparatus is in the first configuration or the second configuration, and wherein, in the first operating mode, the first display is arranged to provide one or more indications to one or more adjacent user inputs, and in the second operating mode, the first and second displays are arranged to act as displays.

31. A foldable electronic apparatus comprising first and second parts being arranged to be foldable with respect to each other about a folding axis to define first and second apparatus folding configurations, wherein the first and second parts comprise respective first and second means for displaying, wherein the apparatus is arranged to have respective first and second operating modes according to whether the apparatus is in the first configuration or the second configuration, and wherein, in the first operating mode, the first means for displaying is arranged to act as a means for user input, and in the second operating mode, the first and second means for displaying are arranged to act as displays.

32. A foldable electronic apparatus comprising first and second parts being arranged to be foldable with respect to each other about a folding axis to define first and second apparatus folding configurations, wherein the first and second parts comprise respective first and second means for displaying, wherein the apparatus is arranged to have respective first and second operating modes according to whether the apparatus is in the first configuration or the second configuration, and wherein, in the first operating mode, the first means for displaying is arranged to provide one or more indications to one or more adjacent means for user input, and in the second operating mode, the first and second means for displaying are arranged to act as displays.
